(19) United States
(12) Patent Application Publication
(10) Pub. No.: US 2009/0085411 A1
(43) Pub. Date: Apr. 2, 2009

(54) Propulsion Device Using Lorentz Force

(76) Inventor: Zhu Qiang, (US)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 12/192,379

(22) Filed: Aug. 15, 2008

(51) Int. Cl. H02K 47/00

(52) U.S. Cl. 310/10

(57) ABSTRACT

The present disclosure describes a system that uses the Lorentz Force to achieve propulsion and that does not generate a reacting force. In broad terms, the present invention includes a device that generates a magnetic field by generating a changing electric field and a carrier of electrically charged particles in motion. They are fastened together. The Lorentz Force that the electrically charged particles in motion are subject to in the magnetic field generated by changing electric field is the propulsive force of the system.

### FIELD OF THE INVENTION

The present invention is related to a propulsion device. Specifically, it relates to a propulsion device that uses the Lorentz Force to achieve propulsion and that does not generate a reacting force.

### BACKGROUND OF THE INVENTION

### Radiation Magnetic Field and the Lorentz Force

Electrically charged particles in motion and changing electric fields both generate magnetic fields, but the nature of the magnetic fields generated thereby is totally different.

Electrically charged particles in motion generate magnetic fields and the quantity of electricity carried by the particles is not affected by the motion. This indicates that electric energy of the electrically charged particles will not experience any change due to the generation of a magnetic field (or magnetic energy). What is affected by the motion is only the distribution of the electric energy, that is, distribution of the electric field. When the quantity of electricity carried by the particles is certain, the magnetic field generated by electrically charged particles moving in a straight line at an even speed totally depends on the speed of motion of the particles. Also, the magnetic field is a single value function of the speed. That is to say, once the motion state of electrically charged particles is ascertained, electrically charged particles have definite magnetic fields that correspond to them. It can be seen here that magnetic fields generated by electrically charged particles in motion describe the quantity of a state of the state of motion of electrically charged particles. The quantity of state reflects the state of a physical object, which may vary by reference system, but which is impossible to exist independently of the physical object. Therefore, the magnetic field generated by electrically charged particles in motion may vary by reference system, but cannot exist independently of the electrically charged particles. It is a field for the electrically charged particles themselves.

Just like kinetic energy, the magnetic field generated by electrically charged particles in motion also reflects the motion state of a physical object in the form of energy. The difference is that kinetic energy describes a motion state through mass, and the kinetic energy is concentrated on a physical object; whereas the magnetic field generated by electrically charged particles in motion describes a motion state through the quantity of electricity, and the magnetic field is distributed in the space around the particles.

A changing electric field also generates a magnetic field. According to the conservation of energy principle, during the process whereby a changing electric field generates a magnetic field, the total energy of the electromagnetic field remains unchanged. That is to say, while magnetic energy is being constantly generated, electric energy is constantly reduced—magnetic energy is converted from the disappearing electric energy. The process whereby a changing electric field generates a magnetic field is a process whereby energy is converted into a form of magnetic energy from a form of electric energy, whereas electric energy and magnetic energy are both localized separately in an electric field and magnetic field. According to the superposition principle of electric fields, at any moment during the aforementioned process, the initial electric field can be viewed as being formed through the superposition of two electric fields independent of each other: one is an electric field with localized electric energy already converted to magnetic energy; the other is a magnetic field with residual localized electric energy. It is obvious that the first electric field generates a magnetic field, but it has disappeared. Although the latter electric field still exists, it has not generated a magnetic field. Since the two electric fields are independent of each other, the magnetic field generated by the former electric field and the latter electric field are also independent of each other. In other words, during the process whereby a changing electric field generates a magnetic field, the magnetic field and the electric field are independent of each other. The former electric field is also the bone that connects the magnetic field and the device that generates the changing electric field. With its disappearance, the magnetic field generated by the changing electric field not only is independent of the electric field, but is also independent of the device that generates the changing electric field. (Compared with this, during the process whereby electrically charged particles in motion generate a magnetic field, the electric field that serves as the bond linking the magnetic field to the particles always exists.) The changing electric field and the device that generates the changing electric field are only the initial conditions for generating a magnetic field. The magnetic field generated by the changing electric field is a radiation field that has nothing to do with the reference system.

The relationship between the magnetic field generated by the changing electric field and the device that generates the changing electric field is similar to the relationship between electromagnetic waves and an antenna. The antenna is only the initial condition for generating electromagnetic waves. Once electromagnetic waves are generated, they have nothing to do with the antenna—electromagnetic waves exist independently of the antenna.

Note that to generate a radiation field, an electric field must “really” experience a change. Such as the following two situations, the change of the electric field is only a surface phenomenon, therefore, no radiation magnetic field is generated.

Situation one: an electric field of electrically charged particles, whose distribution varies by the difference in the speed of motion of the electrically charged particles. It seems that the magnetic field generated by electrically charged particles in motion comes from changes in an electric field. Actually, the change in the electric field that occurs here comes from the perspective of the observer. The electric field generated by electrically charged particles is a field for the electrically charged particles themselves. To determine whether it has experienced any change, the electrically charged particles should be used as reference. The electric field generated by the electrically charged particles has nothing to do with the speed of motion of the electrically charged particles relative to the electrically charged particles. When the electrically charged particles generate a magnetic field resulting from motion, the electric field has not experienced any change relative to the electrically charged particles. The reason that distribution of the electric field is observed to have changed with the speed of motion of the particles is attributable to the change that occurs to the reference system where the observer is located relative to the electrically charged particles, so the observer “believes” that the electric field has experienced a change. The magnetic field generated by electrically charged particles in motion is not from any change in the electric field. Relatively speaking, it can be viewed as coming from the motion of the electric field.

Situation two: change in the particle electric field caused by change in the quantity of electricity carried by particles will not generate a magnetic field, because in substance, change in the quantity of electricity carried by particles is change in the number of electric charges carried by the particles, whereas the electric field generated by each electric charge carried by the particles has not experienced any change relative to the electric charge that generated and relative to the electrically charged particles.

A changing magnetic field also generates an electric field, but that is another issue, that is, the issue of conversion of magnetic energy to electric energy. By the same token, the electric field generated by a changing magnetic field is independent of the magnetic field. A changing electric field generates a magnetic field, a changing magnetic field generates an electric field, and the most common example is an electromagnetic wave. It is just because the magnetic field generated by a changing electric field and the electric field generated by a changing magnetic field are both radiation fields that electromagnetic waves are generated, which make it possible for electromagnetic waves to spread.

The electric fields of stationary electrically charged particles or electrically charged particles moving in a straight line at an even speed are all radial, and the electric field lines are all straight. Relative to the electrically charged particles, the distribution of the electric fields is also the same. Such a state of electric fields of particles is referred to as “normal state” below. When electrically charged particles have acceleration, the electric fields of electrically charged particles are no longer all radial—the electric fields will experience a horizontal component perpendicular to the radial direction. The generation of the horizontal component has nothing to do with the speed of motion of the particles and only depends on the acceleration of the particles. Relative to the electrically charged particles, the electric field has experienced a change. Since the quantity of electricity carried by the particles remains unchanged, concurrent to the generation of the horizontal component, the radial component is reduced. According to the principle of superposition of electric fields, the horizontal component and the radial component can be viewed as two mutually independent electric fields: a horizontal electric field and a radial electric field. They are discussed separately below.

Regardless of the speed of motion of electrically charged particles, the electric field of electrically charged particles is in a normal state. This reveals that the electric fields of electrically charged particles that experience change due to the fact that electrically charged particles have acceleration have a tendency to return to a normal state. That is to say, the horizontal electric field tends to disappear. The disappeared horizontal electric field will generate a magnetic field—a changing electric field generates a magnetic field. As described above, this magnetic field is a radiation field—electrically charged particles generate electromagnetic radiation. This indicates that when the acceleration of electrically charged particles remains unchanged or increases, the horizontal electric field does not reduce or disappear, and instead remains unchanged or increases. At the same time, the electromagnetic radiation still exists. This seems to conflict with “when a magnetic field is generated, an electric field disappears.” Actually, this is attributable to the concurrent occurrence of an external force action (attributable to the fact that electrically charged particles have acceleration) and electromagnetic radiation. The external force keeps the electric field of the electrically charged particles changing. The electric field lines keep bending and the horizontal electric field keeps increasing; whereas electromagnetic radiation keeps the electric field of electrically charged particles returning to a normal state. Electric field lines keep returning to being straight, and the horizontal electric field keeps decreasing. When the external force action equals or exceeds the action of electromagnetic radiation, the increased horizontal electric field equals or exceeds the decreased horizontal electric field. At this time, a phenomenon occurs whereby electromagnetic radiation keeps occurring, while the horizontal electric field remains unchanged or keeps increasing.

The radial electric field experiences change because under an external force action, some of the electric fields of electrically charged particles change from being radial originally to being horizontal. Assume that the electric charges of electrically charged particles can be divided into two parts: the electric fields of some of the electric charges all become horizontal; while the electric fields of some other electric charges still remain radial. The electric fields of the latter electric charges have not experienced any change and are all in a normal state. The number of these electric charges determines the size of the radial electric fields intensity. It can be seen that change of the radial electric fields is equivalent to change of the electric fields caused by the change in the number of electric charges carried by the electrically charged particles. As described above, this will not generate electromagnetic radiation.

Although generation of electromagnetic radiation by electrically charged particles with acceleration is attributable to change in the electric fields of electrically charged particles, the essence of radiation is that the electric fields of changing electrically charged particles have tendency to return to a normal state.

Summing up the above description, the magnetic field generated by electrically charged particles in motion is a field for the electrically charged particles themselves. It is an integral whole of the electrically charged particles; whereas the magnetic field generated by a changing electric field is a radiation field that is independent of the electric field and the device that generates the electric field.

The magnetic field generated by the changing electric field is independent of the device that generates the changing electric field, therefore, when electrically charged particles in motion are subject to the Lorentz Force in the magnetic field generated by the changing electric field, the device that generates the changing electric field is not subject to a reacting force.

### Coil and Radiation Magnetic Field

When a time varying electric current passes through a coil, a magnetic field is generated in the coil. An induced electric field is generated in the coil winding. Generally, an induced electric field is also time varying. In a stable state, due to resistance of an externally added electric field, no electric current can be generated by an induced electric field. A changing induced electric field will generate a magnetic field. At this time, the magnetic field in the coil is generated by the superposition of two magnetic fields. One of them is a magnetic field generated by electric current, which is a magnetic field generated by electrically charged particles in motion. This is a magnetic field generated due to the speed of movement of the electrically charged particles and depends on the size of the electric current. The other is a magnetic field generated by an induced electric field, that is, a magnetic field generated by a changing electric field. This is a magnetic field generated due to the fact that electrically charged particles have acceleration and depends on the frequency of the electric current. The magnetic field generated by an induced electric field is a radiation field that is independent of the coil.

Although the magnetic field generated by an induced electric field is a radiation field, generally, the coil will not radiate electromagnetic waves to the outside. This is because concurrent with being a transmission antenna, the coil is also a reception antenna—the magnetic field radiated thereby is all received by itself. The phenomenon whereby the coil receives the magnetic field radiated by itself is the phenomenon of the self induction of the coil.

### SUMMARY OF THE INVENTION

One purpose of the present invention is to produce a propulsive force and that does not generate a reacting force. Another purpose the present invention is to produce a propulsive force without the help of any external medium, and the present invention can achieve propulsion in a vacuum. Another purpose the present invention is to produce a propulsive force without the use of any propellant. Another purpose the present invention is to produce a propulsive force by relying on electric energy.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent construction do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawing in which:

FIG. 1 is a main view of the preferred device made based on the present invention.

FIG. 2 is the left view of the preferred device made based on the present invention.

FIG. 3 is a 3D schematic the preferred device optimized and made based on the present invention.

### DETAILED DESCRIPTION OF THE INVENTION

The present invention is a system that achieves propulsion by using the Lorentz Force and that does not generate a reacting force. In broad terms, the present invention mainly includes two parts: one part is a device that generates a magnetic field through a changing electric field that is generated; the other part is the carrier of electrically charged particles in motion. These two parts are fixed together. Their relative positions to each other are such that electrically charged particles in motion are in the magnetic field generated by a changing electric field, and that the direction of the movement of electrically charged particles is not parallel to the direction of the magnetic field.

The relative position between the device that generates a changing electric field and the carrier of electrically charged particles in motion will subject electrically changed particles in motion to the Lorentz Force in the magnetic field generated by the changing electric field. Such Lorentz Force is the propulsive force generated by the system. Since the device that generates a changing electric field will not be subject to a reacting force due to the generation of this Lorentz Force and at the same time, the device that generates a changing electric field is fastened to the carrier of the electrically charged particles in motion, when the carrier of the electrically charged particles in motion is in motion under the action of this Lorentz Force, it will drive the device that generates a changing electric field to move with it. Thus, the system achieves propulsion.

### Detailed Description of the Preferred Embodiment

The preferred device of the present invention selects a coil (solenoid) as the device that generates a magnetic field by generating a changing electric field and selects a conductor as the carrier for electrically charged particles in motion.

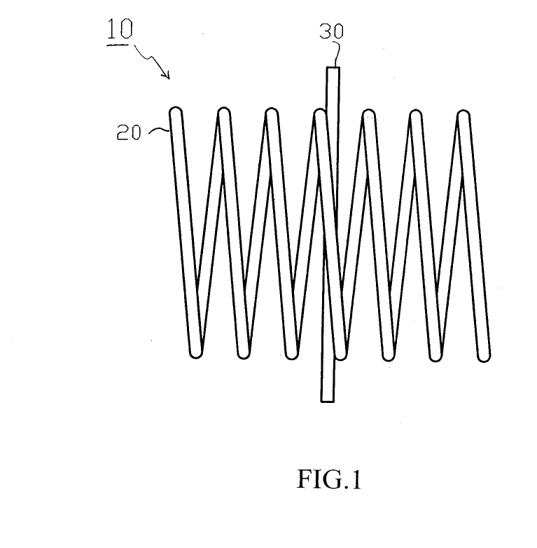

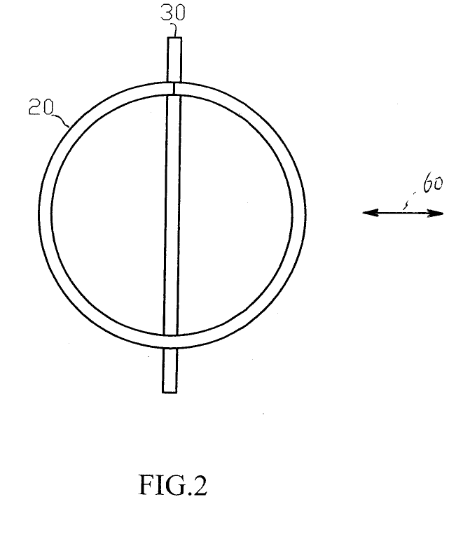

Refer to FIG. 1 and FIG. 2, which describe the preferred device of the present invention. As shown in the figures, system 10 comprises a coil 20 and a conductor 30. Conductor 30 threads through coil 20. The two are fastened together but are insulated from each other. The relative position between them is such that the electrically charged particles in motion in conductor 30 are in the magnetic field generated by coil 20 and that the direction of the motion of the electrically charged particles is not parallel to the direction of the magnetic field.

When a time varying electric current flows through coil 20, coil 20 will generate an induced electric field. During a steady state, the changing induced electric field will generate a magnetic field independent of coil 20. At this time, when a electric current also flows through conductor 30, conductor 30 will be subject to an Ampere force in the magnetic field generated by the induced electric field (the macro expression of the Lorentz Force). The direction of this force is 60 as shown in FIG. 2. This Ampere force is the propulsive force generated by system 10. Since coil 20 and conductor 30 are fastened together, when conductor 30 moves under the action of this Ampere force, coil 20 will move together with it, thus system 10 achieves propulsion.

Since the direction of the magnetic field generated by the induced electric field is time varying, to achieve propulsion, the electric current in conductor 30 should also be time varying. The two should have the same frequency, with a phase difference that is an integer multiple of a ½ cycle.

Although this configuration showed by FIG. 1 and FIG. 2 has been depicted in a preferred embodiment, the present invention can be carried out using conductive coils having any of a variety of shapes and sizes.

### Detailed Description of the Optimized Preferred Device

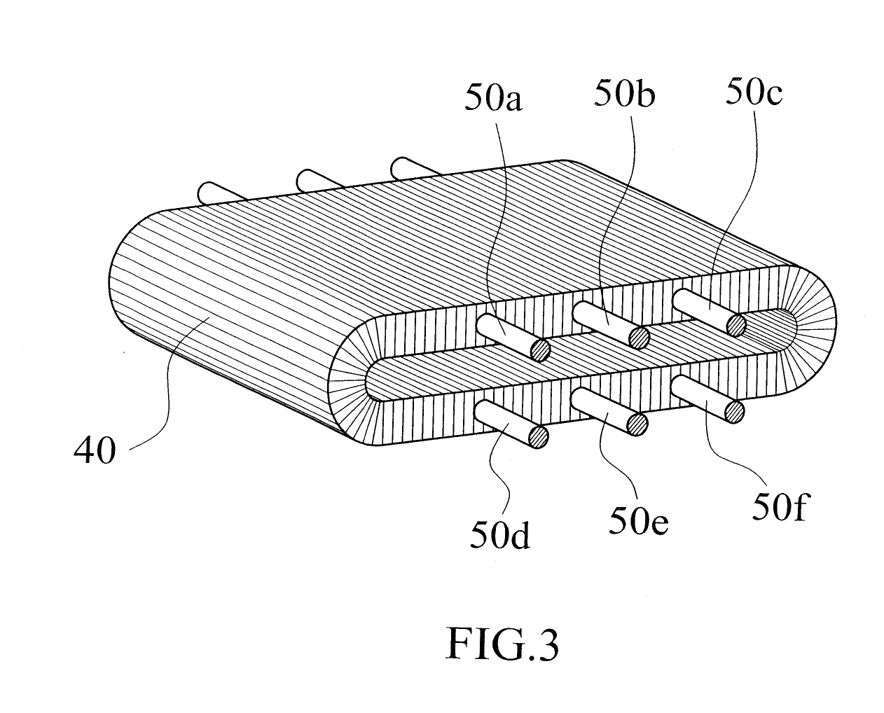

The present disclosure provides an optimized preferred device. Refer to FIG. 3. As shown in FIG. 3, this device is basically identical to the device described in FIG. 1 and FIG. 2. The difference is that it uses a closed annular 40 and a series of conductors 50a, 50b, 50c, 50d, 50e and 50f. Conductors 50a, 50b, 50c, 50d, 50e and 50f respectively thread through coil 40 and are fastened together to coil 40.

Coil 20 as shown in FIG. 1 and FIG. 2 generates magnetic fields that are distributed inside and outside the coil. Annular coil 40 as shown in FIG. 3 can eliminate possible adverse impact generated by magnetic fields outside the coils.

As shown in FIG. 3, at any time, the direction of magnetic field where conductors 50a, 50b, 50c exist and the direction of magnetic field where conductors 50d, 50e, 50f exist are opposite. Therefore, the electric current in conductors 50a, 50b, 50c and the electric current in conductors 50d, 50e and 50f have a ½ cycle phase difference.

To enhance the magnetic induction intensity of the radiation magnetic field in the coils, coil 40 can be made of multiple coils; coils that make up coil 40 are connected in parallel in the electric circuit.

The present disclosure includes that contains in the appended claim, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. A system that uses the Lorentz Force to achieve propulsion and that does not generate a reacting force comprising:
at least one device that generates a magnetic field by generating a changing electric field;
at least one carrier of electrically charged particles in motion;
the device that generates a magnetic field by generating a changing electric field and the carrier of electrically charged particles in motion are fastened together, the relative position between them is such that the electrically charged particles in motion are in the magnetic field generated by changing electric field and that the direction of the motion of the electrically charged particles is not parallel to the direction of the magnetic field generated by changing electric field;
the Lorentz Force that the electrically charged particles in motion are subject to in the magnetic field generated by changing electric field is the propulsive force of the system.

2. The system described in claim 1 wherein a coil is used as the device that generates a magnetic field by generating a changing electric field;
and wherein a conductor is used as the carrier for electrically charged particles in motion.

3. The system described in claim 2 wherein an annular structure is used for the coil.

4. A system for generating propulsion using Lorentz forces comprising:
a winding which carries a time varying electric current, the time varying electric current generating an induced electric field and a magnetic field, the magnetic field being independent of the winding;
a conductor that is threaded through, connected to, but insulated from the winding, the conductor carrying an electric current, wherein the conductor is subject to an Ampere force in the magnetic field generated by the induced electric field, and wherein the Ampere force is the propulsive force of the system.

5. The system of claim 4 wherein the winding is a closed annular coil.

6. The system of claim 4 wherein multiple conductors are threaded through the winding.
